(19) United States
(12) Patent Application Publication
(10) Pub. No.: US 2008/0136617 A1
(43) Pub. Date: Jun. 12, 2008

(54) System for Downloading Turn Signals

(76) Inventors: Robert McCall White, Danville, PA (US); Ted Tsuchiyama, Alamo, CA (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/616,046

(22) Filed: Dec. 26, 2006

Related U.S. Application Data
(60) Provisional application No. 60/869,567, filed on Dec. 12, 2006.

(51) Int. Cl. B60Q 5/00; B60Q 1/26

(52) U.S. Cl. 340/474; 381/86; 340/475

(57) ABSTRACT

A system for storing and playing tones operated by a turn signal comprising a memory for storing at least one predetermined audio output and a player for playing an audio signal from the memory which is activated by the turn signal.

### CLAIM OF PRIORITY

This application claims benefit to provisional application 60/869,567, filed on Dec. 12, 2006, entitled “System for Downloading Turn Signals,” which is incorporated herein by reference.

### FIELD OF THE INVENTION

The present invention is directed toward the field of automotive turn signal systems. In particular, the present invention is directed to a system for storing and playing audio files when a turn signal is activated.

### BACKGROUND OF THE INVENTION

Individualized ring tones have become very popular in recent days. There are a multitude of systems and devices for downloading ringtones and other sounds. The majority of these technologies are directed to cell phones and the like. While there have been technologies directed toward playing downloaded sounds, none have been used in or with automotive turn signals. The following are exemplary patents which relate to automotive turn signals.

U.S. Pat. No. 6,426,695 to Pagano discloses a volume control for an automobile turn signal indicator. The volume control allows the driver to raise or lower the volume of the clicking sound that is produced when a turn signal indicator is activated. As such, the driver is able to increase the volume of the audible clicking sound when operating in an environment having a high background noise (i.e. a radio or traffic) or when the driver is hearing impaired.

U.S. Pat. No. 6,154,125 to McAuley discloses an audible pedestrian alert system for use with vehicles having a wide turning radius such as buses and trucks. The device is disposed in the rear wheel well of the vehicle and is operatively connected to a conventional vehicle turn signal circuit, including a battery and a turn signal switch operable to selectively connect the battery through a switching device to at least a first turn signal indicator lamp through a first contact point and to at least a second turn signal indicator lamp through a second contact point. The device includes a sound generating device and a timing and signal conditioning circuit operably connected to the turn signal switch for connecting the battery to the sound generating device. Upon activation of the turn signal switch, a pulsed tone is audible for a pre-determined time.

U.S. Pat. No. 5,309,143 to Brown discloses a vehicle turn signal malfunction warning system that alerts the vehicle driver when a turn signal indication is not cancelled after a predetermined time period. The device comprises a modular housing that is plug-compatible with all standardized flasher units in use and requires no wiring to be connected to the turn signal system or to the vehicle electrical system. The system includes a full-wave rectifier connected across the inputs of the standard turn signal flasher and is powered solely by the voltage derived from the turn signal system. The warning system includes a first time base circuit, a second time base circuit, a gating means, and a tone generator means. The first time base circuit is arranged to be fully charged by the first turn signal pulse through the full-wave rectifier and should discharge approximately 2.5 seconds after the turn signal pulse train ends. The second time base circuit begins charging when the first time base is fully charged, and accumulates a charge until the first time base circuit resets. The cumulative charge of the second time base circuit is connected through a zener diode to a gate, and thence to an audible transducer. After the turn signal has operated for a predetermined time period, a sufficient number of turn signal pulses will have been generated to raise the voltage of the second time base circuit above the zener diode threshold, the gating means will switch on and the audible warning will sound. Cancellation of the turn signal indication will immediately stop the audible warning.

U.S. Pat. No. 5,264,827 to Giovanni discloses a turn signal reminder circuit for warning a vehicle driver that the vehicle turn signals may have been inadvertently left actuated. Turn signal flasher pulses are low pass filtered to provide a continuous enabling signal which initiates the operation of an astable, multivibrator timer circuit. The timer circuit switches asymmetrically between a first occurring longer-time, partial cycle, and a shorter-timer, partial cycle. A sound alarm is enabled by the timer during each shorter-time, partial cycle. The alarm is actuated by flasher pulses when the alarm is enabled, but is disabled and the timer circuit is reset in response to operation of the vehicle brake. A pulse detecting circuit for using flasher pulses to turn on the timing circuit has no large capacitor and this permits miniaturization.

While there have been a number of systems devoted to turn signal sound systems, there has not been a system directed toward producing preselected sounds when an auto turn signal is activated.

It is an object of present invention to provide a system in which an end user can download a turn signal.

It is a further object of the present invention to provide a system in which an end user can access a plurality of turn signals.

These objects of the present invention will become apparent from the detailed description and claims which follow.

### SUMMARY OF THE INVENTION

In accordance, the invention is a system for storing and playing tones operated by a turn signal comprising memory for storing at least one predetermined audio output and a player for playing an audio signal from the memory which is activated by the turn signal.

In a further embodiment, the invention is a system for storing and playing tones operated by a turn signal comprising memory for storing a plurality of predetermined audio outputs and a player for playing an audio signal from the memory which is activated by the turn signal.

In yet a further embodiment, the invention is a system for storing and playing tones operated by a turn signal comprising a memory for storing a plurality of predetermined audio output files; a controller for accessing the output files; and a player connected to the controller for playing an audio tool from the memory, which is activated by the turn signal in a first direction and for playing on a second audio file when the turn signal is activated in a second direction.

### BRIEF DESCRIPTION OF THE FIGURES

FIG. 1 is a block diagram of the present invention.

FIG. 2 is a diagram of the system for downloading audio file.

FIG. 3 is a diagram illustrating a system for playing audio files.

FIG. 4 is a graphical interface for accessing and programming sound files.

### DETAILED DESCRIPTION OF THE INVENTION

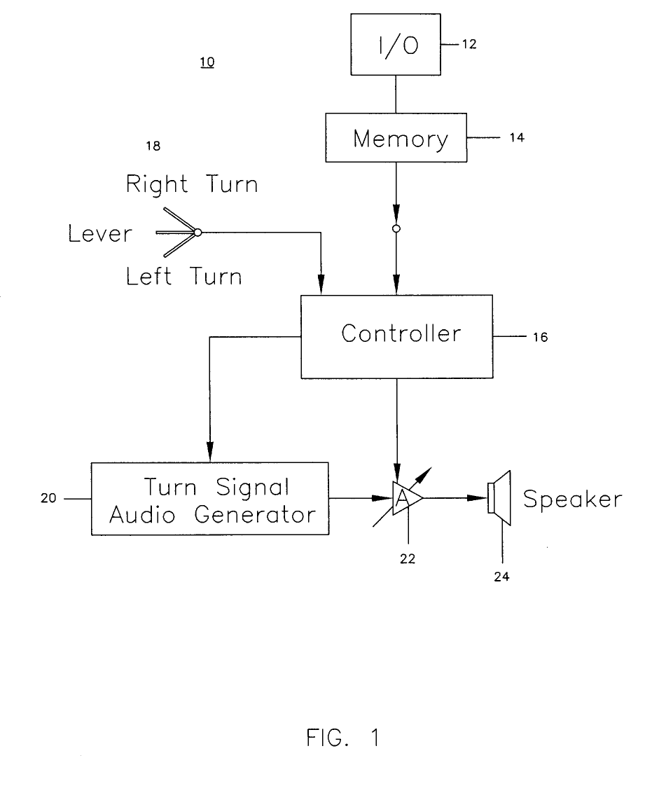

The present invention is described with reference to the enclosed Figures, wherein the same numbers are used where applicable. FIG. 1 is a block diagram illustrating a system in accordance with an exemplary embodiment of the present invention. As shown in FIG. 1, the invention comprises a system 10 which stores and plays audio files when a turn signal is activated. Therefore, instead of the annoying turn signal clicking, the operator can hear music, a loved one's voice, or other preselected sounds. As will be discussed herein, the invention provides a system which stores preselected sound files.

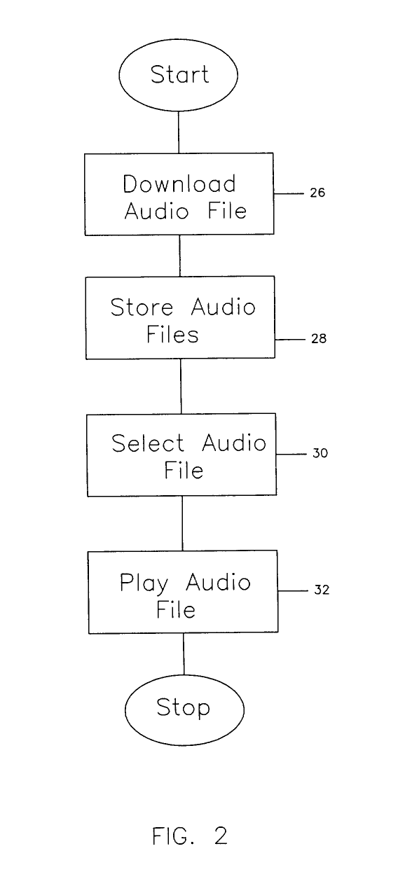

As shown, the system 10 includes an input/output device 12. The device may include a keypad and a memory device to download audio files. A structure of the system will be described with reference to FIG. 2. The invention includes a controller 16. The memory 14 stores a plurality of tones and messages.

The right and left turn activation lever 18 is affixed to the controller 16. When activated, the controller 16 plays a file from memory on the turn signal audio generator 20. This may be adjustable by an amp 22. The sound plays out of a speaker 24. It is to be appreciated that the system can be used to facilitate a wide variety of sounds.

FIG. 2 illustrates an algorithm for downloading and playing audio files 26. The system stores audio files 28. The system can then select audio files 30 and play the audio files 32.

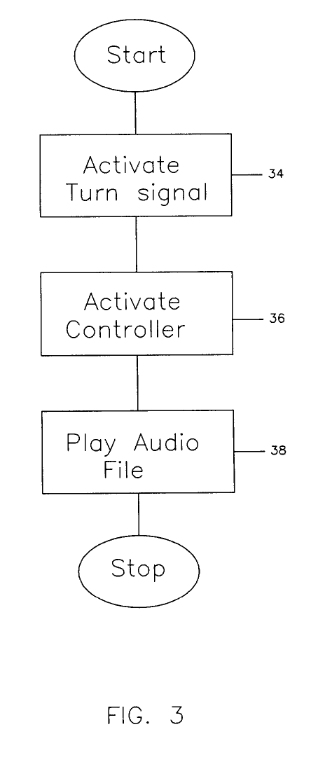

In FIG. 3, the algorithm of the system is shown. Once the user activates the turn signal 34, the controller is activated 36, which plays the audio files 38.

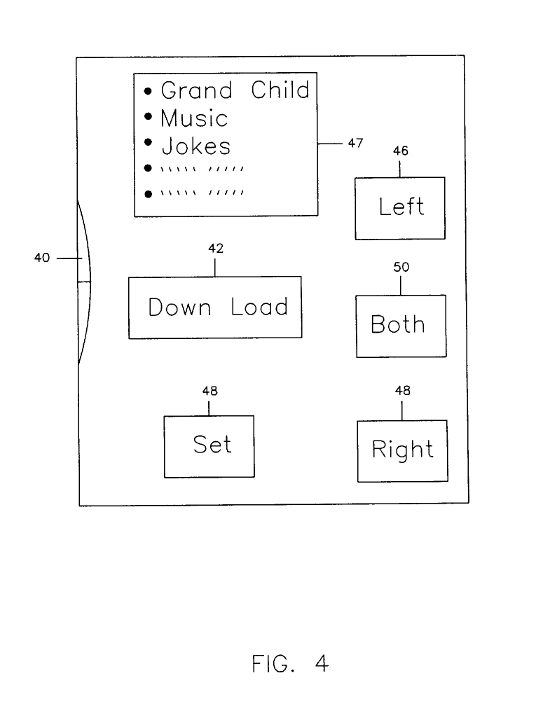

As shown in FIG. 4, the invention may have a graphical interface. A memory slot 40 accepts a memory device. The system 10 can download 42 the files and set 48 specific files as shown in the graphical window 47. The user can select sound files such as a grandchild's voice or other voices. The device can be selectively set for left turns 46, right turns 48 or both 50.

The present invention has been described with reference to the enclosed preferred emboidment. It is to be appreciated that the other emboidments fulfill the spirit and scope of the present invention and that the true nature and scope of the invention will be determined with respect to the claims appended hereto.

1. A system for storing and playing tones operated by a turn signal comprising:
memory for storing at least one predetermined audio output; and
a player for playing an audio signal from the memory, which is activated by the turn signal.

2. A system for storing and playing tones operated by a turn signal comprising:
a memory for storing a plurality of predetermined audio outputs; and
a player for playing an audio signal from the memory, which is activated by the turn signal.

3. A system for storing and playing tones operated by a turn signal comprising:
a memory for storing a plurality of predetermined audio output files;
a controller for accessing the output files; and
a player connected to the controller for playing an audio tool from the memory which is activated by the turn signal in a first direction and for playing on a second audio file when the turn signal is activated in a second direction.
